(19) United States
(12) Patent Application Publication
(10) Pub. No.: US 2010/0328353 A1
(43) Pub. Date: Dec. 30, 2010

(54) METHOD AND SYSTEM FOR DISPLAYING AN IMAGE ON A DISPLAY OF A COMPUTING DEVICE

(75) Inventors: Jeffrey Douglas McDonald, Foxborough, MA (US); Lonne R. Lyon, Rochester, NY (US)

Correspondence Address: FOLEY HOAG, LLP;PATENT GROUP, WORLD TRADE CENTER WEST, 155 SEAPORT BLVD, BOSTON, MA, 02110, US

(73) Assignee: SolidFX LLC, Foxborough, MA (US)

(21) Appl. No.: 12/827,445

(22) Filed: Jun. 30, 2010

Related U.S. Application Data
(60) Provisional application No. 61/221,814, filed on Jun. 30, 2009.

(51) Int. Cl. G09G 5/373; G06T 11/20

(52) U.S. Cl. 345/671; 345/441

(57) ABSTRACT

A computer implemented method of displaying an image on a display of a computing device, includes the steps of: (a) displaying an image on the display of the computing device; (b) receiving a user input for drawing a mark on the image indicative of a desired operation to be performed on the image; (c) displaying the mark on the image; (d) determining an operation to be performed on the image based on the mark; and (e) preparing and displaying an image as modified or generated by the operation.

### CROSS REFERENCE TO RELATED APPLICATION

This application claims priority from U.S. Provisional Patent Application Ser. No. 61/221,814, filed on Jun. 30, 2009, entitled “Methods and System Suitable for Interaction with Graphical Systems Having Limited Refresh Rate Performance,” which is hereby incorporated by reference.

### BACKGROUND

The present application generally relates to methods and systems for displaying images and enabling user interaction with the images.

Real time interaction with information displayed on computer output devices, such as Liquid Crystal Displays (LCDs), Cathode Ray Tubes (CRTs), etc., using graphical user interfaces (GUIs) is commonplace. Computing devices as limited as those found embedded in cell phones are often capable of allowing the user to interact with displayed images via touch screens, pointing devices, and keyboards. General purpose computers support a wider range of input devices such as the computer mice, joysticks, trackballs, touch screens, pen-enabled displays, and digitizing tablets that facilitate user control over what is displayed and in what form.

Computer users have come to expect a near instantaneous response from inputs to be reflected by way of appropriate changes in the content of the graphical display. For example, a computer user might select an object shown on a display (by pointing at the object with a cursor controlled by a computer mouse and pushing and holding a designated button on the mouse) and then translate that object to another part of the display. This operation is very intuitive because the feedback to the user is in near real time. The latency between the user's hand moving the mouse and the motion of the selected object on the display may be measured in milliseconds and is generally not perceived by the user. If this latency grows to a point where there is a perceptible lag between input and output, the user experience is diminished.

For many reasons this latency can become quite large. For example, there is an emerging class of display technology called Electrophoretic displays (commonly known as Electronic Paper Displays (EPD) or e-ink based displays) that have very limited full screen refresh rate performance with latencies reaching up to a full second or more while being able to update very small portions of the display quickly. Another reason is many embedded systems do not have the computational performance required to do complex graphics in a real time manner. One or more of these limitations combined can result in a user experience that does not have an interactive feel.

### BRIEF SUMMARY OF EMBODIMENTS OF THE INVENTION

A computer implemented method of displaying an image on a display of a computing device is provided in accordance with one or more embodiments of the invention. The method includes the steps of: (a) displaying an image on the display of the computing device; (b) receiving a user input for drawing a mark on the image indicative of a desired operation to be performed on the image; (c) displaying the mark on the image; (d) determining an operation to be performed on the image based on the mark; and (e) preparing and displaying an image as modified or generated by the operation.

In accordance with one or more further embodiments, a computer system is provided for displaying an image on a display. The computer system includes at least one processor, a display coupled to the at least one processor, a user input mechanism coupled to the at least one processor to allow a user to interact with an image on the display using gestures, and memory associated with the at least one processor. A program is supported in the memory having a plurality of instructions which, when executed by the at least one processor, causes that at least one processor to: (a) display an image on the display; (b) receive a user input from the user input mechanism for drawing a mark on the image indicative of a desired operation to be performed on the image; (c) display the mark on the image; (d) determine an operation to be performed on the image based on the mark; and (e) prepare and display an image as modified or generated by the operation.

In accordance with one or more further embodiments, a computer program product is provided for displaying an image on a display of a computing device. The computer program product resides on a computer readable medium having a plurality of instructions stored thereon which, when executed by a processor of the computing device, causes that processor to: (a) display an image on the display of the computing device; (b) receive a user input for drawing a mark on the image indicative of a desired operation to be performed on the image; (c) display the mark on the image; (d) determine an operation to be performed on the image based on the mark; and (e) prepare and display an image as modified or generated by the operation.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified illustration of a computer system in which techniques for displaying images in accordance with one or more embodiments can be implemented.

FIG. 2 is a simplified flowchart illustrating a method for displaying images in accordance with one or more embodiments.

FIGS. 3A-3C are exemplary screen shots illustrating an image magnification process in accordance with one or more embodiments.

FIGS. 4A-4C are exemplary screen shots illustrating an image translation process in accordance with one or more embodiments.

### DETAILED DESCRIPTION

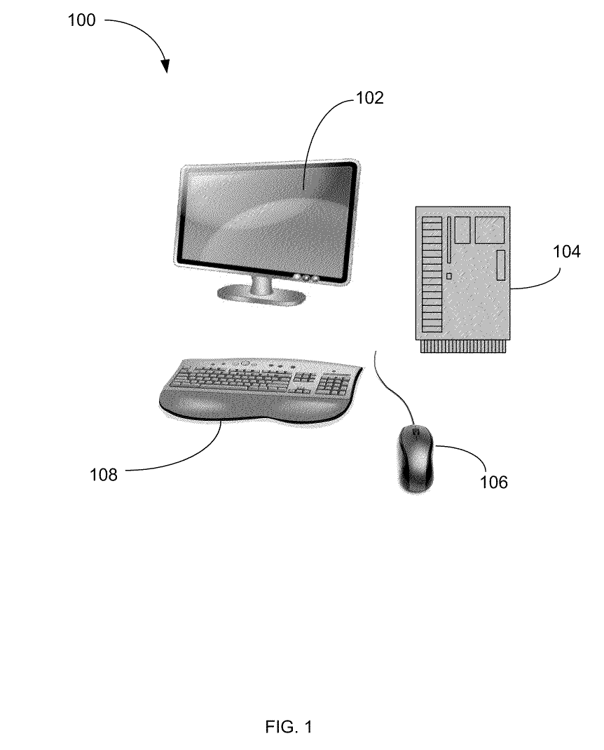

FIG. 1 is a simplified illustration of an exemplary computer system 100 in which methods for displaying images in accordance with one or more embodiments of the invention can be implemented. The computer system displays information on a display 102 driven by a computer 104, takes user input from one or more peripheral input devices 106, 108 also attached to the computer 104, and updates the display 102 with modified information in a manner defined by the user input.

In some embodiments, the computer 104 is a general purpose computer including at least one processor running a commercially available operating system that supports one or more applications. In alternative embodiments, the computer can be an embedded computer in electronic devices such as, but not limited to, mobile telephones, personal digital assistants (PDAs), electronic document viewers, and electronic book readers.

The input devices can include, but not limited to, keyboards 108, computer mice 106, track balls, touch screens, digitizer tablets, pen-enabled displays, motion sensing devices such as accelerometers, or any other input device that allows users to provide data to, and interact with, the computer.

The display 102 can be a dedicated electronic display device based on technologies such as, but not limited to, Liquid Crystal Displays (LCD), Electrophoretic or Electronic Paper Displays (EPD), Organic Light Emitting Diode Displays (OLED), Plasma displays, a cholesteric interferometric modulator based on microelectromechanical systems, or Cathode Ray Tubes (CRTs).

As used herein, the terms “image”, “information”, “visual representation”, and “graphics” are generally used interchangeably to describe anything shown on the display by the computer. The source of such displayed material can include, but is not limited to, digital images, computer models rendered to an image or bitmap using a graphics subsystem with related Application Programming Interfaces (APIs), or documents defined by a page description language and rendered to the display.

Examples of digital image source material include, but are not limited to, bitmap files, JPEG files, TIFF files, and raw images from digital cameras.

Examples of Graphics APIs include, but are not limited to, DirectX (from Microsoft) and OpenGL (from SGI).

Examples of Page Description Languages include, but are not limited to, PDF (from Adobe), PostScript (from Adobe), and PCL (from Hewlett Packard).

One or more embodiments of the invention are directed particularly to magnification (i.e., “zooming”) and translation (i.e., “panning”) operations on images. In non-limiting examples discussed below, such operations can be performed on complex graphical images presented on a high latency electrophoretic display that is driven by a low performance embedded processor. Latency measured from the time of user input to the final requested visual representation is dominated by the combination of the computational effort needed to prepare an updated graphical view and the time needed to physically update the display with the resulting computed view. Cues are provided to the user of the device using the methods described herein. In one or more embodiments, similar methods can be applied to faster displays and computer systems in applications where it is deemed important to allow the user to first input a full specification of an operation before the actual operation is started even though real time processing may be feasible.

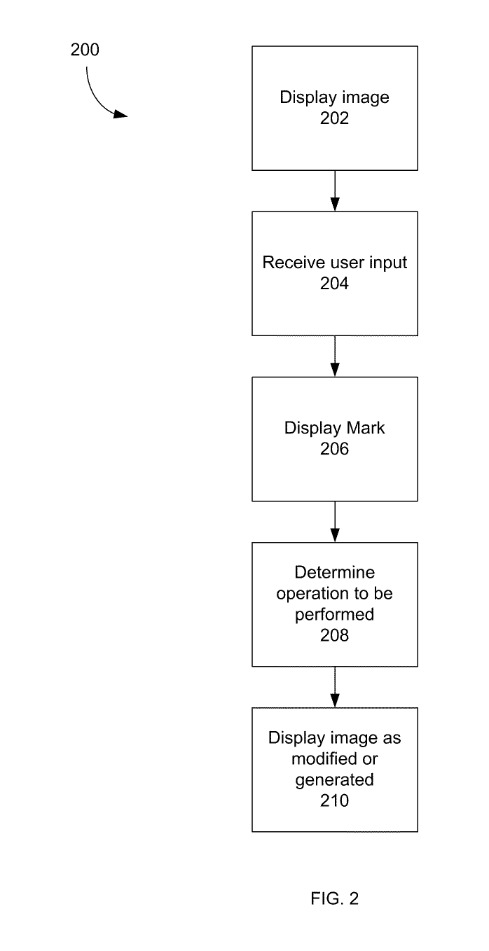

FIG. 2 is an exemplary flow chart 200 generally illustrating a method of displaying images In accordance with one or more embodiments.

At step 202, an image is shown to a user on the display of a computing device operated by the user.

At step 204, a user input is received for drawing a mark on the image, which is indicative of a desired operation to be performed on the image.

At step 206, the mark is displayed on the image by the computing device.

At step 208, the computing device determines which operation is to be performed on the image based on the mark.

At step 210, the image as modified or generated by the operation is displayed to the user.

The user input at step 204 is typically received after the user has had time to examine and evaluate information shown on the display.

In some embodiments, the operation desired by the user is a magnification or zoom operation. In this case, the user wishes to focus his or her attention to a small part of the displayed image for closer examination. A magnification or zoom operation that is fully defined by the user before the operation begins is advantageous for many reasons, including system performance, display latency, or application workflow.

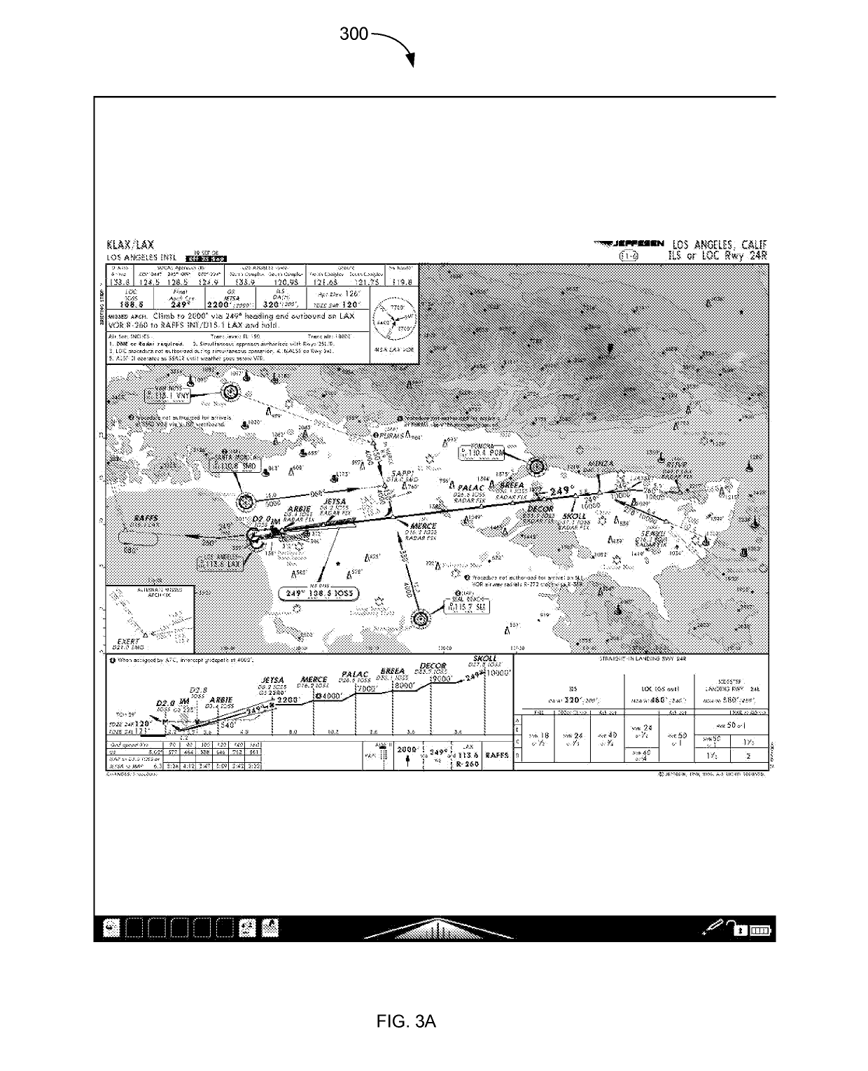

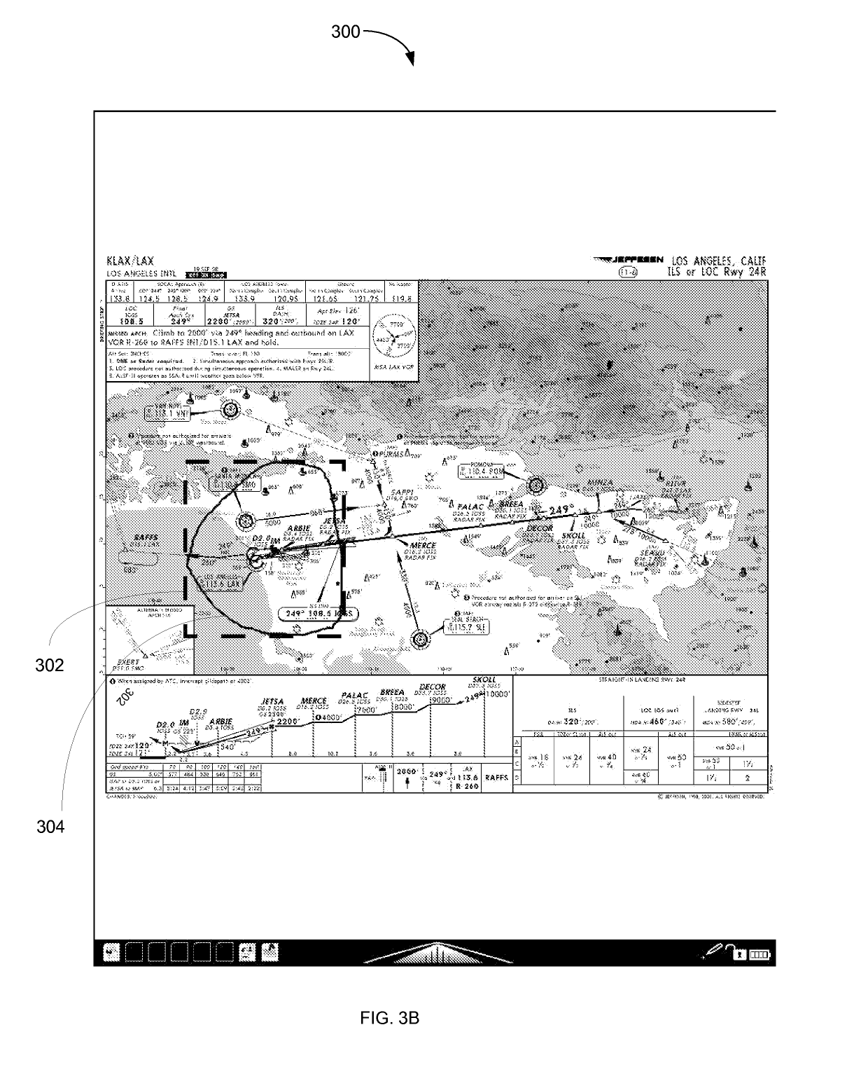

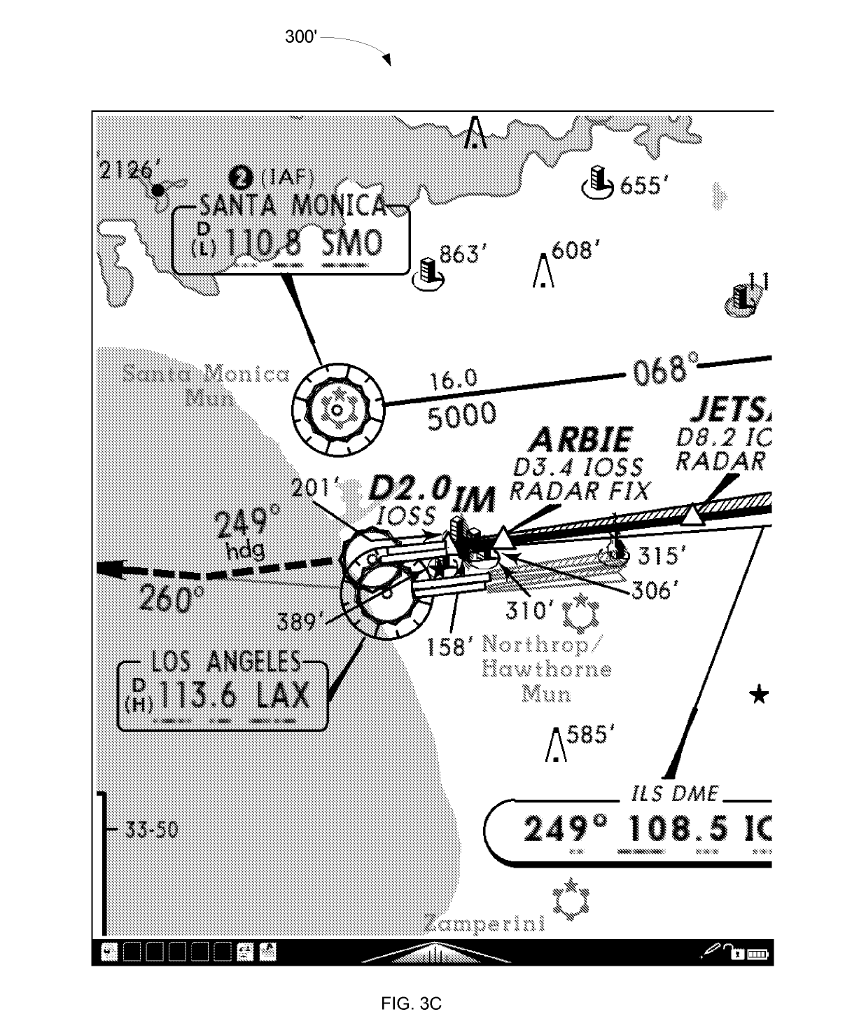

By way of example, the user can use a pointing device to bracket the area of interest to be magnified. As used herein, the term ‘bracket’ refers to a mark or the process of drawing a mark that generally defines an area of the image to be magnified by specifying the upper and lower extents of the area in both the X and Y axis. As illustrated in the example of FIG. 3B discussed below, a bracket can be, e.g., a mark that at least partially encircles or otherwise forms a border around some or all of the general area of interest. The user input provides an indication as to when the bracketing process is starting and when it is complete. For example, when utilizing a computer mouse, this could correspond to a button press to indicate the start and a release of the same button to indicate the stop of the bracketing process. In this indirect pointer example, a cursor is used to choose a starting position for the bracket. This is because the position on the display to which the mouse is pointing is not directly related to the position of the mouse itself.

When utilizing a pen-enabled or touch display, a pen or a finger touching the display surface could indicate the start of the bracketing and the pen or a finger leaving the surface of the display could indicate the completion of the bracketing process. In this direct pointer case, the display is not required to show a cursor when choosing a starting position for the bracket since the position of the pen or finger on the display is explicit.

In some embodiments, the operation desired by the user is a translation or pan operation. In this case, the user wishes to move or translate the displayed image across the screen such that new information from the opposite direction of the translation vector is moved into view on the display in an amount proportional to the length of the translation vector. In this situation, it is implied that the rendered size of the information being examined exceeds the physical size of the display being employed. A pan operation that is fully defined by the user before the operation begins is desired for any number of reasons, including system performance, display latency, or application workflow.

By way of example, the user can use a pointing device to gesture or stroke a path that specifies a point where the gesture begins and where that point should be located on the display once the gesture ends. This involves indication of when the gesture is starting and when it is complete. When utilizing a computer mouse, this could correspond to a button press to start and the release of the same button to stop the operation. In this indirect pointer case, a cursor is used to choose a starting position for the gesture. This is because the position on the display to which the mouse is pointing is not directly related to the position of the mouse itself.

When utilizing a pen-enabled or touch display, a pen or a finger touching the display surface could start the gesture and the pen or a finger leaving the surface of the display could indicate the completion of the gesture. In this direct pointer case, the display is not required to show a cursor when choosing a starting position for the bracket since the position of the pen or finger on the display is explicit.

In some embodiments, the operation desired by the user relates to a particular point on the displayed image. For example, the operation could be a request for information relating an item shown on the image. The operation might also be an action related to a button on the image. In this case, the user draws a small mark or point at a location of interest on the image using the user input techniques previously described.

In step 206, as the bracket, line, point, or other mark is traced by the user from a gesture or stroke, it is drawn on the display in a form compatible with the display technology being utilized.

Once the mark has been drawn, the intent of the stroke or gesture made by the user is interpreted in step 208 as will be described in further detail below. If the computing device determines that the user intends for a zoom operation to be performed, the zoom area is ascertained from the users' stroke or gesture by determining the minimum and maximum extents in both the X and Y axis. With these extents, combined with a known mapping of the image to the display, a new mapping is determined such that the bracketed area is expanded to fit on the display.

If the computing device determines in step 208 that the user intends for a translation or pan operation to be performed, the translation vector is ascertained from the users' stroke or gesture by subtracting the origin of the gesture from the last point in the gesture on the display. With this vector, combined with a known mapping of the original image to the display, a new mapping is determined such that the image is translated as defined by the gesture.

The computing device may also determine at step 208 that the user has tapped a point or other small mark on the image and intends the device to perform some action related to a particular location of the mark on the image.

At step 210, a new view is prepared by the computer based on the mapping determined from the bracket extents or the translation vector, while leaving the original image and drawn gesture visible. If the display is capable, and the preparation is to take some time, some visual indication can be provided to the user that the new view is being prepared. If the target display is unable to support such an indication efficiently, a secondary display that can support such an indication, sound cues, or available lights/LEDs can also be used as an indication that the operation is in progress. Once the new view or image is fully prepared, only then is the display update performed in as efficient manner as possible for the display utilized.

At step 208, the computer determines which operation is to be performed on the image based on the mark drawn by the user. For example, the computer can determine whether a zoom and pan operation was intended by the user as described in the C++ code subroutine provided below as an example how the user input can be interpreted. Points along the path of the mark drawn by the user with a pointing device or finger are input to the subroutine in the form of Standard Template Library (STL) vectors of X and Y positions. If the vectors differ in length or no points are passed to the subroutine, the return indicates neither ZOOM or PAN. A baseline vector is then calculated that points from the start of the gesture to the end of the gesture. This is followed by the calculation of N_SAMPLE_VECTORS (8 in the sample code shown) vectors that represent successive segments of the gesture. The angle each of these makes with the baseline vector is determined in the form of a cosine formed via a dot product between normalized baseline and segment vectors. Each of the resulting cosine values is compared against a threshold value and a count of segments that exceed this threshold value is calculated. The percentage of segments that diverge from the baseline vector is used to determine if the intent was a straight line indicating a translation vector or a bracket to define a zoom target area. The thresholds and other constants can be adjusted to obtain the desired sensitivity. The illustrated values have proven very effective in the example application that follows.

```
///////////////////////////////////////////////////////////////////////////////
// Pen stroke analysis
//
enum {
    PEN_STROKE_PAN,
    PEN_STROKE_ZOOM,
    PEN_STROKE_OTHER
};
#define PEN_STROKE_LINE_THRESHOLD_COSINE  0.75F
#define PEN_STROKE_LINE_DIVERGENCE_THRESHOLD0.05F
#define N_SAMPLE_VECTORS  8
int pen_stroke_type(vector<int> &xv, vector<int> &yv)
{
```

| | |
|---|---|
| int | npts; |
| double | nx, ny; |
| double | d; |
| int | stride = 1; |

```
    npts = xv.size( );
    if (npts!=yv.size( )|| npts==0)
        return PEN_STROKE_OTHER;
    // calculate the vector from start to end
    nx = xv.back( ) − xv.front( );
    ny = yv.back( ) − yv.front( );
    LOGPRINTF(“Baseline vector [%f, %f]”, nx, ny);
```

| | |
|---|---|
| if ( | nx*nx < MIN_ZOOM_PIXELS*MIN_ZOOM_PIXELS |
| && | ny*ny < MIN_ZOOM_PIXELS*MIN_ZOOM_PIXELS) |
| | return PEN_STROKE_CROP; |

```
    d = sqrt(nx*nx + ny*ny);
    nx = nx / d;
    ny = ny / d;
    // now examine a sequence of segments from the stroke to
    // determine if they share  the same approximate vector
    if (npts > N_SAMPLE_VECTORS)
    {
        stride = npts / N_SAMPLE_VECTORS;
    }
    else
        stride = 1;
```

| | |
|---|---|
| int divergence_cnt | = 0; |
| int cnt | = 0; |

```
    for (int i=stride; i<npts − stride; i+=stride)
    {
        double snx = xv[i] − xv[i−stride];
        double sny = yv[i] − yv[i−stride];
        d = sqrt(snx*snx + sny*sny);
        snx = snx / d;
        sny = sny / d;
        // calculate the cosine of the angle between the reference
      // vector and the segment via a dot product
        float dot = nx*snx + ny*sny;
        cnt++;
        if ( d>10.0 &&
        dot<PEN_STROKE_LINE_THRESHOLD_COSINE)
            divergence_cnt++;
    }
    // what fraction diverged from the baseline vector by more than
    permitted angle
    float df = (float)divergence_cnt / cnt;
    if (df < PEN_STROKE_LINE_DIVERGENCE_THRESHOLD)
        return PEN_STROKE_PAN;
    else
        return PEN_STROKE_ZOOM;
}
```

Provided below is another example of C++ code subroutine used for interpreting the intent of the user input. The code below classifies the mark made by the user as a point, a line, or “other shape.” The other shape is anything that does not fit into a point or line definition, and whose X and Y extents are used to determine the area on the image to be zoomed in.

```
          ///////////////////////////////////////////////////////////////////////////
// User mark types
enum {
    PEN_STROKE_PAN,
    PEN_STROKE_ZOOM,
    PEN_STROKE_POINT,
    PEN_STROKE_OTHER
};
```

| | |
|---|---|
| #define | MIN_ZOOM_PIXELS 60 // cutoff for a small stroke |

being interpreted as a tap

| | | |
|---|---|---|
| #define | MAX_WIDTH | 768 // normally determined at runtime |
| #define | MAX_HEIGHT | 1024 // normally determined at |
| | | runtime |
| #define | MAX_OFFSET | 60 // used to decide if mark is straight |

enough to be considered a line
///////////////////////////////////////////////////////////////////////////////
// interpret a user mark
int pen_stroke_type(vector<int> &xv, vector<int> &yv)
{

| | |
|---|---|
| int | npts; |
| int | x_max = 0; |
| int | x_min = MAX_WIDTH; |
| int | y_max = 0; |
| int | y_min = MAX_HEIGHT; |
| double | nx, ny; |
| double | denominator; |

```
    //make sure we have reasonable input data
    npts = xv.size( );
    if (npts!=yv.size( ) || npts<2)
        return PEN_STROKE_OTHER;
// see if mark small enough to fit the definition of a point
//  by looking at the extents of the mark made by user in both dimensions
for (int i=0; i<stroke->m_n; i++)
    {
        int x = stroke->m_pts[i].x;
        int y = stroke->m_pts[i].y;
        if (xv[i] < x_min) x_min = xv[i];
        if (xv[i] > x_max) x_max = xv[i];
        if (yv[i] < y_min) y_min = yv[i];
        if (yv[i] > y_max) y_max = yv[i];
}
if (x_max−x_min <= MIN_ZOOM_PIXELS && y_max−y_min <=
MIN_ZOOM_PIXELS)
{
return PEN_STROKE_POINT;
}
    // calculate the vector from first point to last
    nx = xv.back( ) − xv.front( );
    ny = yv.back( ) − yv.front( );
    // calculate the length of the vector from first point to last
    denominator = sqrt(nx*nx + ny*ny);
    // if the result is very small it must be that start and finish of the
    stroke define
    // essentially the same point
    // ... hence the mark must encircle an area indicating a zoom operation
    if (denominator <= MIN_ZOOM_PIXELS)
        return PEN_STROKE_ZOOM;
    // if any point is displaced from the start point to finish point vector
// by more than MAX_OFFSET it is a zoom/crop operation
    for (int i=0; i<npts−1; i++)
    {
        // determinant yields the perpendicular distance of other points
        off the line
        if (fabs( nx*(yv.front( )−yv[i]) − ny*(xv.front( )−xv[i]) ) /
denominator > MAX_OFFSET)
            return PEN_STROKE_ZOOM;
    }
    // if we get here the user approximated a straight line
    return PEN_STROKE_PAN;
}
```

By way of example, the methods described herein can be used to display aviation approach charts, in which document data rendered from a page description language can be used to represent the aviation approach charts. An instrument rated pilot is qualified to land at many worldwide airports when weather conditions may not allow for visual acquisition of the runway until at a very low altitude. At such airports, special charts are needed that encapsulate in detail the procedure for getting from a certain position in airspace at a higher altitude, to a much lower altitude very close to the landing runway. Such procedures are designed to take into consideration terrain, obstacles, noise sensitivity, and issues specific to the airport location. A decision is made by the pilot after completing the inbound portion of the procedure as to whether a safe landing can be made from this point or whether a missed approach must be declared and flown as detailed on the same chart.

An airport with such procedures may have just a single instrument approach or numerous different approaches that may utilize different runway surfaces, landing directions, and different navigational equipment and crew training requirements. There are other charts such as airport diagrams, noise abatement requirements, as well as detailed arrival and departure procedures that may be separately defined for busy airports. Various government agencies around the world are a source of such charts but availability and chart format variation between different countries can become overwhelming. Most international flying and even much of the instrument flying done in the United States is done using materials provided by a company named Jeppesen (a Boeing Company). A legal equivalent to government charts worldwide, Jeppesen charts maintain a more consistent worldwide format.

Instrument approach charts have been made available in an electronic form for some time. They have been deployed on various portable personal computers for handheld use in the cockpit, but battery life, screen readability in bright sunlight, and system cost has kept printed paper versions in most cockpits. New electrophoretic display technologies (Electronic Paper Displays) mimic the look of a paper presentation with extremely low power usage. These displays are generally excellent in direct light and can be illuminated with standard cockpit lighting during night operations. One drawback of these displays is a refresh latency of up to a second.

Additionally, to retain the power savings of the display and to lower costs, the computer processors usually deployed in devices using electrophoretic displays are not very powerful compared to state of the art processors powering modern personal computers. Additionally, graphics coprocessors or other special purpose accelerator hardware is usually not available on these systems because of similar power and cost constraints. Since the chart images can have significant complexity, it can take on the order of one or more seconds to render them for display with typical embedded processors. This combined with the display latencies makes real time interaction with the charts virtually impossible.

Most commercially available electrophoretic displays support an ability to update areas of the display in a lower latency fashion with a trade off in the form of a loss in displayed image quality. A complete screen refresh is needed to recover the generally best possible image quality after several updates. Such displays, and their associated display controllers, sometimes offer a direct capability to draw limited width lines overlaid on the current display contents. In the following examples, that capability is exploited to provide a near real-time feedback of the gesture made using the pointing device. In this particular example, an iRex Technologies DR1000S e-reader is utilized as the computer and display, while the pointing device is an integrated Wacom digitizing tablet mounted behind the display. A special stylus is used in conjunction with the digitizing tablet.

A zoom or magnification example in accordance with one or more embodiments is illustrated in FIGS. 3A-3C. FIG. 3A shows a complex Instrument Landing System (ILS) approach chart 300 into the Los Angeles International airport (KLAX) as displayed on an iRex DR100S e-reader. There is considerable detail on the chart so an ability to focus on specific regions of the chart is important.

A user of the approach chart 300 desires to magnify a portion of the chart displayed on the e-reader, and accordingly draws a bracket around the area of interest. FIG. 3B shows the chart just as the user finishes drawing the bracket (which in this case is a rough circle 302) around an area of interest.

The computer uses an algorithm (e.g., the code described above) to determine that the user is bracketing the region and desires the area to be magnified to fill the display. A dashed line 304 is optionally generated to show the extent of the area to be displayed after magnification.

The requested, magnified view is then prepared. Using the example hardware, a small, static dialog can be simultaneously displayed asking the user to “Please Wait” (or providing some other indication that the user request is being processed) until the magnified view has been prepared. In this example, the operation may then take about 2 seconds to complete.

Although the drawing of the mark 302 and the presentation of the wait dialog may have some minor negative impact on local image quality, it is generally inconsequential as the display is fully updated with the requested magnified view 302′ as shown in FIG. 3C, once available.

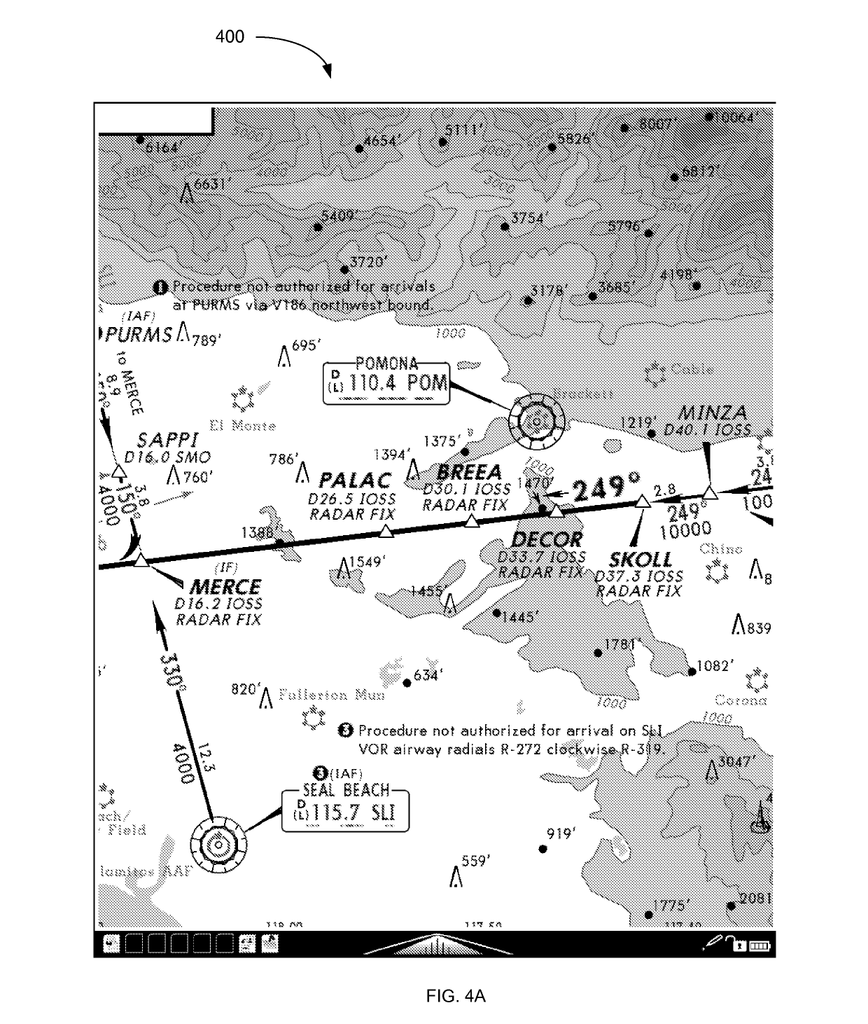

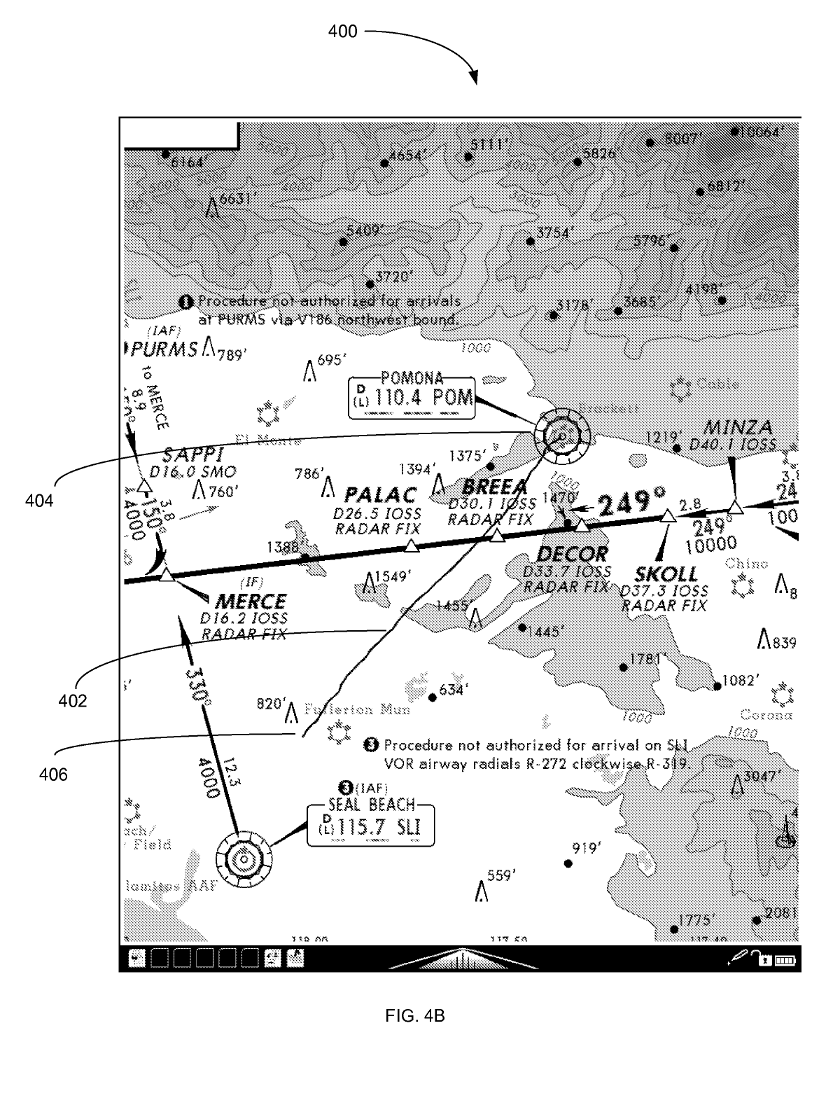

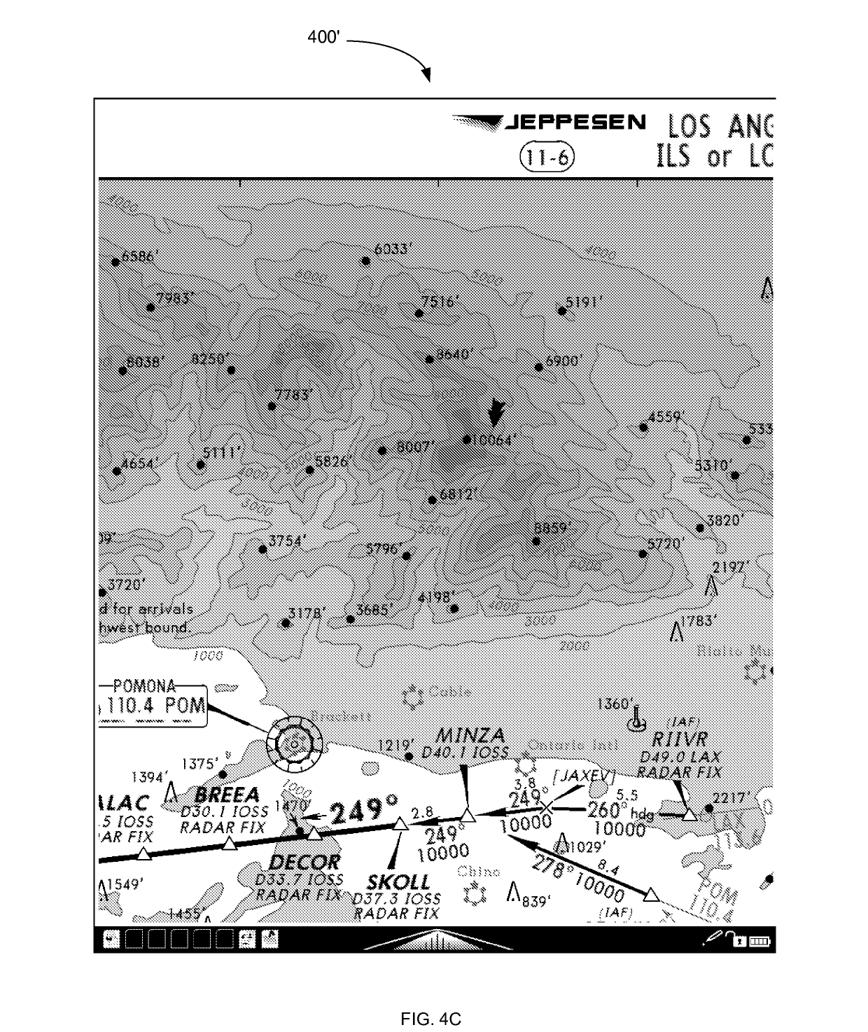

A translation or pan example in accordance with one or more embodiments is illustrated in FIGS. 4A-4C. FIG. 4A shows a magnified region 400 of the same Instrument Landing System (ILS) approach chart into the Los Angeles international airport, again as displayed on an iRex DR100S e-reader by way of example.

A user of the device wishes to perform a translation or pan operation on the chart 400, and accordingly draws a rough line 402 on the chart 400. FIG. 4B shows the chart just as the user finishes drawing the rough line 402 from a point of interest 404 to a new position 406 where the user would like to move that point of interest to on the display.

The computer uses an algorithm (e.g., the code described above) to determine that the user is requesting that the image be translated across the display with the vector described by the pen's end point minus the pen's start point.

The requested, panned or translated view is then prepared. A small, static dialog asking the user to “Please Wait” (or providing some other indication that the user request is being processed) can be simultaneously displayed. In this example, the operation may then take about 2 seconds to complete.

Although the drawing of the line on the image and the presentation of the wait dialog has some minor negative impact on local image quality, it is generally inconsequential as the display is fully updated with the requested region 400′ once it is available as shown in FIG. 4C.

A user may also wish to have an operation performed relating to a particular location on the aviation chart. In this case, the user makes a small mark or point on the chart at a location of interest. The aviation chart may be geo-referenced, in which case the mark is associated with real earth latitude/longitude coordinates. As one possible operation, the computing device can search databases to determine if some item of interest is close to the real point. (Closeness can be defined as being within some defined cutoff distance.) An item of interest could be, e.g., airports, special navigation points on charts called fixes, and ground based navigation aids such as VORs. If an item of interest is found, the computing device can then display information on that item for the user to examine. If nothing is close to the point, the computing device can interpret the point in a default manner (e.g., an unzoom operation). If the mark is on a button on the image, the computing device performs the action of the button.

Providing real time feedback on the user request itself, when the subsequent operation will be lengthy can enhance the user experience.

Aviation approach charts represent only one particular example of using the techniques described herein. It should be understood that such techniques can be used in very diverse applications, including but not limited to the following:

There are many electronic documents that are suitable for display on higher latency devices such as book readers and electronic documents. These include maintenance manuals for complex machinery, legal documents, financial documents, medical charts and imaging, and large format textbooks. It is advantageous in each of these examples to facilitate the types of interaction described herein.

Delaying an operation until a complex gesture made by a user is complete may be desirable regardless of display performance. Any time a more precise stroke or gesture or sequence of gestures needs to be input, delaying any update over whatever amount of time is needed by the user may be important. Depicting the gestures on the display in real time provides valuable feedback to the user.

It is to be understood that although the invention has been described above in terms of particular embodiments, the foregoing embodiments are provided as illustrative only, and do not limit or define the scope of the invention. Various other embodiments are also within the scope of the claims. For example, elements and components described herein may be further divided into additional components or joined together to form fewer components for performing the same functions.

The techniques described above are preferably implemented in software, and accordingly one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD or DVD ROM), a removable storage device (e.g., external hard drive, memory card, or flash drive), or downloaded via the Internet or some other computer network. In addition, although the various methods described are conveniently implemented in one or more computers selectively activated or reconfigured by software, one of ordinary skill in the art would also recognize that such methods may be carried out in hardware, in firmware, or in more specialized apparatus constructed to perform the specified method steps.

Method claims set forth below having steps that are numbered or designated by letters should not be considered to be necessarily limited to the particular order in which the steps are recited.

What is claimed is:

1. A computer implemented method of displaying an image on a display of a computing device, comprising the steps of:
(a) displaying an image on the display of the computing device;
(b) receiving a user input for drawing a mark on the image indicative of a desired operation to be performed on the image;
(c) displaying the mark on the image;
(d) determining an operation to be performed on the image based on the mark; and
(e) preparing and displaying an image as modified or generated by the operation.

2. The computer implemented method of claim 1 wherein the operation comprises a magnification operation and wherein the mark defines an area of the image to be magnified by at least partially bracketing the area.

3. The computer implemented method of claim 1 wherein the operation comprises a translation operation and the mark comprises a stroke defining a translation vector for panning the image on the display.

4. The computer implemented method of claim 1 wherein the mark comprises a point on the image, and wherein the operation comprises displaying a different image or identifying an item of interest located proximate the point.

5. The computer implemented method of claim 1 wherein the image comprises an aviation chart.

6. The computer implemented method of claim 5 wherein the aviation chart is an approach chart or an en-route chart.

7. The computer implemented method of claim 1 wherein the image comprises a document page.

8. The computer implemented method of claim 1 further comprising performing an operation not involving modification of the image in response to a further user input.

9. The computer implemented method of claim 8, wherein the further user input comprises a tap on the display or a mark made on a button drawn on the image.

10. A computer system for displaying an image on a display, comprising:
at least one processor;
a display coupled to the at least one processor;
a user input mechanism coupled to the at least one processor to allow a user to interact with an image on the display using gestures;
memory associated with the at least one processor; and
a program supported in the memory having a plurality of instructions which, when executed by the at least one processor, cause that at least one processor to:
(a) display an image on the display;
(b) receive a user input from the user input mechanism for drawing a mark on the image indicative of a desired operation to be performed on the image;
(c) display the mark on the image;
(d) determine an operation to be performed on the image based on the mark; and
(e) prepare and display an image as modified or generated by the operation.

11. The computer system of claim 10 wherein the operation comprises a magnification operation and wherein the mark defines an area of the image to be magnified by at least partially bracketing the area.

12. The computer system of claim 10 wherein the operation comprises a translation operation and the mark comprises a stroke defining a translation vector for panning the image on the display.

13. The computer system of claim 10 wherein the mark comprises a point on the image, and wherein the operation comprises displaying a different image or identifying an item of interest located proximate the point.

14. The computer system of claim 10 wherein the image comprises an aviation chart or a document page.

15. The computer system of claim 10 wherein the display comprises a liquid crystal display, an electrophoretic display, an organic light emitting diode display, a plasma display, a cholesteric interferometric modulator based on microelectromechanical systems, or a cathode-ray tube display.

16. The computer system of claim 10 wherein the computer system comprises a personal computer, a mobile communications device, a personal digital assistant, an electronic document viewer, or an electronic book reader.

17. The computer system of claim 16 wherein the user input mechanism comprises a keyboard, computer mouse, trackball, touchscreen, a digitizing tablet with a stylus pen, or motion sensing device.

18. A computer program product for displaying an image on a display of a computing device, the computer program product residing on a computer readable medium having a plurality of instructions stored thereon which, when executed by a processor of the computing device, causes that processor to:
(a) display an image on the display of the computing device;
(b) receive a user input for drawing a mark on the image indicative of a desired operation to be performed on the image;
(c) display the mark on the image;
(d) determine an operation to be performed on the image based on the mark; and
(e) prepare and display an image as modified or generated by the operation.

19. The computer program product of claim 18 wherein the operation comprises a magnification operation and wherein the mark defines an area of the image to be magnified by at least partially bracketing the area.

20. The computer program product of claim 18 wherein the operation comprises a translation operation and the mark comprises a stroke defining a translation vector for panning the image on the display.

21. The computer program product of claim 20 wherein the mark comprises a point on the image, and wherein the operation comprises displaying a different image or identifying an item of interest located proximate the point.

22. The computer program product of claim 18 wherein the image comprises an aviation chart or a document page.

23. The computer program product of claim 18 wherein the user input is received from a user input device that allows the user to interact with the image using gestures.

24. The computer program product of claim 18 further comprising performing an operation not involving modification of the image in response to a further user input.

25. The computer program product of claim 24 wherein the further user input comprises a tap on the display or a mark made on a button drawn on the image.
